(19) United States
(12) Patent Application Publication
(10) Pub. No.: US 2023/0193432 A1
(43) Pub. Date: Jun. 22, 2023

(54) ALUMINUM ALLOY WORKPIECE AND PREPARATION METHOD THEREOF

(71) Applicant: Shaanxi Xinghuaye 3D Technology Co., Ltd., Shaanxi (CN)

(72) Inventor: Nan Kang, Weinan (CN)

(73) Assignee: Shaanxi Xinghuaye 3D Technology Co., Ltd., Shaanxi (CN)

(21) Appl. No.: 18/078,617

(22) Filed: Dec. 9, 2022

(30) Foreign Application Priority Data
Dec. 22, 2021 (CN) 202111584797.0

(51) Int. Cl. C22C 21/12; C22C 1/04; B22F 10/28; B22F 10/36

(52) U.S. Cl. CPC C22C 21/12; C22C 1/0416; B22F 10/28; B22F 10/36; B22F 2999/00; C22C 2200/06

(57) ABSTRACT

The present disclosure provides an aluminum alloy workpiece and a preparation method thereof. By optimizing a composition of the aluminum alloy workpiece, the aluminum alloy workpiece can be prepared by laser powder bed fusion (LPBF) in the preparation method, thereby forming a target metallographic phase. The preparation method overcomes the problem that the composition of a high temperature-resistant and high-strength aluminum alloy designed based on the traditional casting and forging process cannot be matched with the LPBF, and makes full use of rapid cooling of the LPBF to prepare an aluminum alloy composition of a target crystal phase. The preparation method combines the aluminum alloy composition with the LPBF to achieve mutual promotion, thereby forming a target workpiece, such that an aluminum alloy with high strength and toughness at room temperature/high temperature can be prepared by the LPBF.

### CROSS-REFERENCE TO RELATED APPLICATION

This patent application claims the benefit and priority of Chinese Patent Application No. 20211 1584797.0, filed with the China National Intellectual Property Administration on Dec. 22, 2021, the disclosure of which is incorporated by reference herein in its entirety as part of the present application.

### TECHNICAL FIELD

The present disclosure belongs to the technical field of metal additive manufacturing and preparation, and particularly relates to an aluminum alloy workpiece and a preparation method thereof.

### BACKGROUND

In recent years, the aviation, aerospace and automotive industries have developed rapidly. In the field of mesotherm end parts (200° C. to 350° C.), novel materials and structural design engineering aiming at lighter weight and higher toughness may provide important supports for the low-energy-sustainable development model. In the field of high-end equipment, there is an urgent need for the overall precision forming of high-strength and complex high temperature-resistant aluminum alloy components. Laser powder bed fusion (LPBF)-based additive manufacturing technology of complex aluminum alloy components has become a new research hotspot in the field of integrated structure-function manufacturing for the metal materials due to irreplaceable advantages in material processing and structural design. However, due to the inherent high laser reflectivity and easy oxidation of the aluminum alloy, only two alloys such as the cast aluminum alloy ZL104 (AlSi₁₀Mg) and the Al—Mg—Sc—Zr developed by AIRBUS can be maturely used in LPBF. Preliminary research results show that although LPBF processed Al—Si and Al—Mg—Sc—Zr alloys have excellent room temperature properties, their tensile strengths are only about 70 MPa to 90 MPa and 30 MPa to 40 MPa at 350 ° C., respectively, which cannot meet the application requirements of mesothermal end parts. However, the traditional Al—Cu alloys (2xxx series) with desirable temperature strength are prone to hot cracks during the LPBF preparation during the rapid directional solidification of the molten pool due to a wide solidification temperature range, resulting in imprecise forming. Recently, research teams from the United States, Japan and other countries have made certain progress in the additive manufacturing of high-temperature aluminum alloys such as Al—Fe and Al—Ce series, from the foundation of casting process. However, due to the non-uniform distribution of a large number of low-plastic Al—Fe and Al—Ce intermetallic compounds, there are still poor manufacturability and insufficient room-temperature plasticity, such that it is impossible to directly prepare complex components by the LPBF in large scales.

### SUMMARY

In order to overcome the shortcomings of the prior art, an objective of the present disclosure is to provide an aluminum alloy workpiece and a preparation method thereof. The present disclosure can avoid uneven distribution and poor room-temperature plasticity of intermetallic compounds in the existing aluminum alloy system.

To achieve the above objective, the present disclosure adopts the following technical solutions:

The present disclosure provides an aluminum alloy workpiece, including the following components by mass fraction: 1.0% to 2.5% of Fe, 1.5% to 3.0% of Cu, 1.0% to 2.0% of Cr, 0.5% to 1.1% of Ti, 0.4% to 1.0% of Zr, and Al as a balance.

As a further improvement of the present disclosure, the technical solutions include:

Preferably, the aluminum alloy workpiece includes less than 0.2% of impurity elements by mass fraction.

Preferably, the aluminum alloy workpiece includes greater than 2.5% and less than 3.5% of Fe and Cr in total by mass fraction.

Preferably, the aluminum alloy workpiece includes less than 2.0% of Ti and Zr in total by mass fraction.

Preferably, the aluminum alloy workpiece includes less than 0.01% of oxygen by mass fraction.

Preferably, the aluminum alloy workpiece has a tensile strength of greater than or equal to 500 MPa at room temperature.

Preferably, the aluminum alloy workpiece has a yield strength of greater than or equal to 400 MPa at room temperature.

Preferably, the aluminum alloy workpiece has an elongation of greater than or equal to 8% at room temperature.

Preferably, the aluminum alloy workpiece has a tensile strength of greater than or equal to 200 MPa at 350° C.

Preferably, the aluminum alloy workpiece has a yield strength of greater than or equal to 160 MPa at 350° C.

Preferably, the aluminum alloy workpiece has an elongation of greater than or equal to 8% at 350° C.

The present disclosure further provides a preparation method of the aluminum alloy workpiece, including the following steps:

step 1, draw a three-dimensional diagram of a workpiece to be prepared, and formulating process parameters during printing; and

step 2, printing a configured and baked aluminum alloy powder in a Laser powder bed fusion (LPBF) printer to obtain the aluminum alloy workpiece.

Preferably, in step 1, the process parameters comprise a laser power, a scanning speed, a scanning line spacing, a rotation angle, a layering thickness, an oxygen content, and a substrate preheating temperature.

Preferably, in step 2, a particle size distribution of the aluminum alloy powder comprises: a D10 powder has a particle size of 10 μm to 25 μm, a D50 powder has a particle size of 30 μm to 45 μm, and a D90 powder has a particle size of 50 μm to 60 μm.

Preferably, in step 2, the aluminum alloy powder is baked at 100° C. to 120° C. for 2 h to 4 h.

The present disclosure has the following beneficial effects over the prior art:

The present disclosure provides an aluminum alloy workpiece. In the aluminum alloy workpiece, by optimizing the content of each element, the aluminum alloy workpiece has a heterogeneous structure in the final metallographic phase, a combination of columnar grains and equiaxed grains, and has an excellent intermetallic compound reinforcement. Accordingly, the aluminum alloy workpiece has excellent tensile strength, high-temperature stability, and room-temperature strength, such that the alloy has desirable mechanical properties at room temperature and high temperature, showing high strength, excellent crack resistance, and desirable plasticity.

The present disclosure further provides a preparation method of an aluminum alloy workpiece. By optimizing a composition of the aluminum alloy workpiece, the aluminum alloy workpiece can be prepared by LPBF in the preparation method, thereby forming a target metallographic phase. The preparation method overcomes the problem that the composition of a high temperature-resistant and high-strength aluminum alloy designed based on the traditional casting and forging process cannot be matched with the LPBF, and makes full use of rapid cooling of the LPBF. Through setting a composition system of the aluminum alloy workpiece combined with the rapid cooling of the LPBF, an aluminum alloy composition of a target crystal phase is prepared by the method. The preparation method combines the aluminum alloy composition with the LPBF to achieve mutual promotion, thereby forming a target workpiece, such that an aluminum alloy with high strength and toughness at room temperature/high temperature can be prepared by the LPBF. The preparation method provides a material system of the aluminum alloy with high strength and toughness at room temperature/high temperature for the LPBF, and expands a use range of the LPBF technology in the field of mesothermal end parts.

Further, the alloy powder used in LPBF of the present disclosure achieves a lower cost during the preparation.

### BRIEF DESCRIPTION OF THE DRAWINGS

FIG. 1 shows a flow chart of the present disclosure;

FIG. 2 shows a state diagram of a powder and its particle size in Example 1;

FIG. 3A-B show micrographs of a finished product prepared in Example 1; where; FIG. 3A is a light microscope image of an LPBF formed part; FIG. 3B is a microstructure of the formed part after etching; and

FIG. 4A-B show performance test results of the alloy prepared in Example 1; where; FIG. 4A is a performance diagram at room temperature; FIG. 4A is a performance diagram at high temperature.

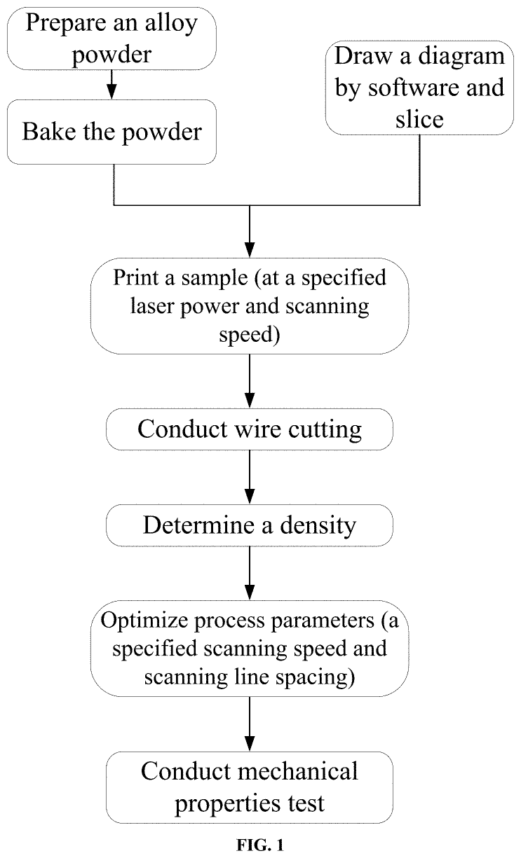

### DETAILED DESCRIPTION OF THE EMBODIMENTS

The present disclosure will be further explained in detail below with reference to the accompanying drawings.

The present disclosure provides an aluminum alloy workpiece, including the following components by mass fraction: 1.0% to 2.5% of Fe, 1.5% to 3.0% of Cu, 1.0% to 2.0% of Cr, 0.5% to 1.1% of Ti, 0.4% to 1.0% of Zr, and Al as a balance. In the alloy system, Al and Fe elements can form an Al₆Fe intermetallic compound reinforcement phase, improving the tensile strength and high-temperature stability. Al, Cu, Cr, and Fe elements may form two quasicrystal reinforcement phases, Al—Fe—Cr and Al—Cu—Fe—Cr, and simultaneously precipitate nano-reinforcement phases such as θ-Al₂Cu. Ti element-Al₃Ti— can improve a high-temperature stability of the quasicrystal phase and refine a size of the quasicrystal phase. Zr and Al elements generate Al₃Zr particles, which can be used as a heterogeneous nucleation core of α-Al grains, refining the grains, realizing the transformation from columnar grain to equiaxed grain, so as to improve a plasticity of the alloy system. In addition, the Al₃Zr phase can also improve a high-temperature stability of the whole system. Meanwhile, Ti and Zr elements may introduce L1₂-type Al₃(Zr, Ti) particles existing at a molten pool boundary during the LPBF forming, with a size of 100 nm to 800 nm. Due to a small lattice mismatch with α-Al, the particles can serve as a heterogeneous nucleation core to promote the transformation of columnar grain to equiaxed grain. Eventually, a heterogeneous structure is formed, consisting of columnar crystals inside the molten pool and equiaxed crystals at the molten pool boundary. Under the action of back stress strengthening, the room temperature strength and toughness of the alloy each are further improved.

Preferably, a total content of Fe and Cr elements is greater than 2.5% and not more than 3.5%. A total content of Ti and Zr elements is greater than 0.9% and not more than 2.0%.

More preferably, in an example, impurity elements have a content of less than 0.2%. Specifically, the impurity elements are impurity alloy elements, as alloy impurities that are inevitably brought in due to process or introduction of raw materials during preparation of the alloy; in the example, an oxygen content is less than 0.01%. Limiting the content of impurity elements and oxygen can avoid the generation of unnecessary brittle intermetallic compounds or metal oxides, thereby avoiding affecting the formation of grains and affecting the content of the entire aluminum alloy.

In an example of the present disclosure, it is defined that there is a tensile strength of greater than or equal to 500 MPa at room temperature, a yield strength of greater than or equal to 400 MPa at room temperature, and an elongation of greater than or equal to 8% at room temperature.

In an example of the present disclosure, properties of the aluminum alloy workpiece at 350° C. are defined, specifically, there are a tensile strength of greater than or equal to 200 MPa at 350° C., a yield strength of greater than or equal to 160 MPa at 350° C., and an elongation of greater than or equal to 8% at 350° C.

In the present disclosure, the above tensile strength, yield strength and elongation can be achieved in these two examples is mainly due to a design of the composition system, the formation of reinforcement phases of various scales in the alloy system may compositely improve the strength and ductility of alloys. Al and Fe elements can form Al₆Fe and Al₁₃Fe₄ intermetallic compound reinforcement phases, improving the tensile strength and high-temperature stability. Al, Cu, Cr, and Fe elements can form two quasicrystal enhancement phases, Al—Fe—Cr and Al—Cu—Fe—Cr. Ti element can improve a high-temperature stability of the quasicrystal phase and refine a size of the quasicrystal phase. Zr and Al elements generate Al₃Zr particles, which can be used as a heterogeneous nucleation core of α-Al grains, refining the grains, realizing the transformation from columnar grain to equiaxed grain, so as to improve a plasticity of the alloy system. In addition, the Al₃Zr phase can also improve a high-temperature stability of the whole system. Moreover, the introduced Ti and Zr elements can also bring about a heterogeneous microstructure composed of equiaxed grains at the molten pool boundary and columnar grains in the molten pool. Under the further back stress strengthening, the alloy can obtain strength-toughness synergy at room temperature. This property may further broaden use of the alloy system in both room-temperature and high-temperature fields, and can be applied in high-temperature oil pipelines, filter elements, engine pistons and other components.

The present disclosure further provides a preparation method of the aluminum alloy workpiece. The aluminum alloy workpiece can be prepared by LPBF in the preparation method. For a target Al—Fe—Cu—Cr—Ti—Zr alloy, rapid solidification of the LPBF is adopted, which has rapid cooling, and shows obvious non-uniform distribution in the temperature gradient and solidification rate at the scale of a single molten pool. Therefore, the LPBF is beneficial to form a reinforced Al-based composite with an Al—Fe—Cr quasicrystal, metastable Al—Cu and Al—Fe phases, and Al₃Ti and Al₃Zr as reinforcement phases in different regions of the molten pool. The composite structure is mainly manifested as: structural characteristics of a duplex microstructure with the equiaxed and columnar grains of α-Al grains on the scale of 100 μm, heterogeneous distribution of the Al—Fe—Cr quasicrystal and Al—Fe phase at the edge and center of the molten pool on the scale of 1 μm to 10 μm, and precipitation strengthening of Al₃Ti, Al₃Zr, and Al₂Cu phases on the nanoscale. As a result, combining the above composite strengthening mechanisms, the alloy at room temperature and high temperature has a significantly improved composite strength, which is suitable for more severe environments. The preparation method specifically includes the following steps:

Step 1, a three-dimensional diagram of a workpiece to be prepared is drawn, and a scanning strategy is formulated; in step 1, the formulated scanning strategy is specifically the process parameters of LPBF, including important parameters such as a laser power, a scanning speed, a scanning line spacing, a rotation angle, a layering thickness, an oxygen content, and a substrate preheating temperature. For the alloy composition in this example, the specific process parameters include: a laser power of 325 W to 400 W, a scanning speed of 1,000 mm/s to 1,400 mm/s, a scanning line spacing of 100 μm to 140 μm, a rotation angle of 17° to 67°, a layering thickness of 0.025 mm to 0.03 mm, an oxygen content of less than 200 ppm|, and a substrate preheating temperature of 150° C. to 195° C., where a residual stress of the part is reduced by heating the substrate.

Step 2, an aluminum alloy powder is prepared according to a target composition, and the aluminum alloy powder is dried.

Preferably, the aluminum alloy powder is prepared by gas atomization at an appropriate ratio of raw material elements. The composition and proportion of aluminum alloy powder are as follows:

TABLE 1
Composition of aluminum alloy powder

| Element | Fe | Cu | Cr | Ti | Zr | Al |
|---|---|---|---|---|---|---|
| Content | 1.0-2.5 | 1.0-3.0 | 1.0-2.0 | 0.5-1.1 | 0.4-1.0 | Balance |
| (wt. %) | | | | | | |

The master alloy impurities have a content of less than 0.2%, and oxygen has a content of less than 0.01%.

Further, particle size distribution and fluidity requirements of the powder are as follows:

TABLE 2
Particle size distribution requirements

| | D10/μm | D50/μm | D90/μm |
|---|---|---|---|
| Indicator requirements (%) | 10-25 | 30-45 | 50-65 |

The aluminum alloy powder has a bulk density of greater than 1.36 g/cm² and a Hall flow rate of less than 80 s/50 g.

As one of the preferred solutions, a powder with a particle size of 15 μm to 53 μm is vacuum-dried at 100° C. to 120° C. for 2 h to 4 h.

Step 3, the baked aluminum alloy powder is printed in an LPBF printer according to the set process parameters, such that a quasi-crystalline reinforced Al-based composite is prepared to obtain high-strength aluminum alloy parts.

The present disclosure will be further described in detail with reference to the specific examples, which are intended to illustrate and not to limit the present disclosure.

### EXAMPLE 1

Step 1, a three-dimensional diagram of an experimental block with optimized process parameters was drawn, and layered slicing was conducted with a scanning strategy at a rotation angle between adjacent layers of 17° and a layer thickness of 0.03 mm.

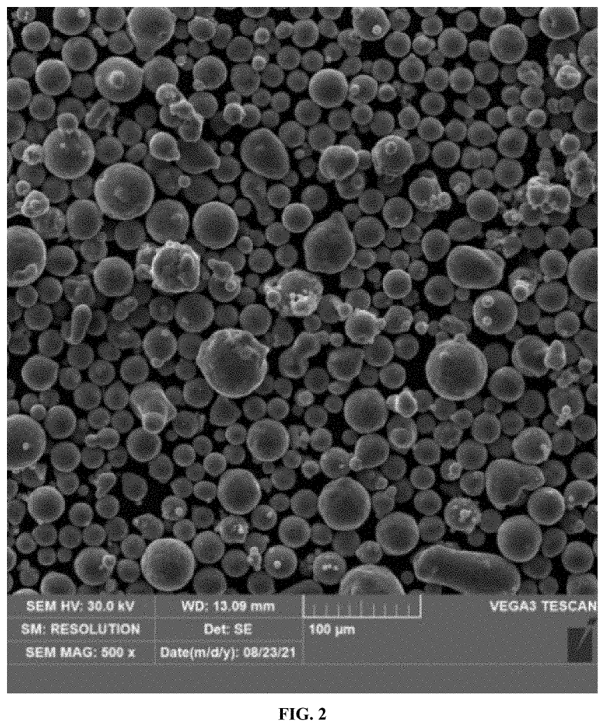

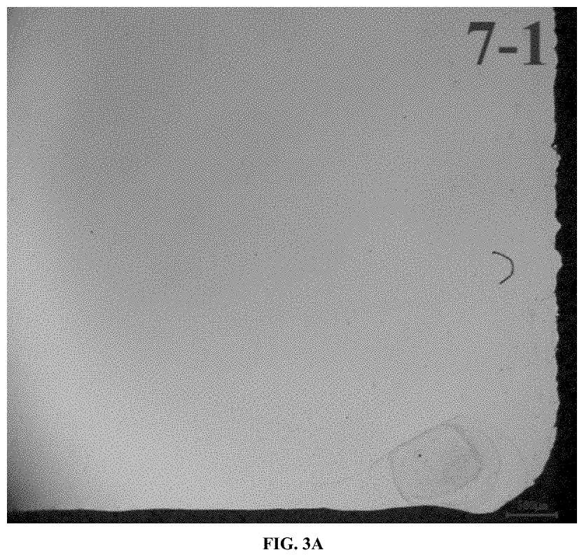

Step 2, an aluminum alloy powder to be baked was prepared, and the aluminum alloy powder included the following components: 2.0% of Fe, 2.0% Cu, 1.0% of Cr, 1.0% of Ti, 1.0% of Zr, and Al as a balance; the aluminum alloy powder had a particle size state shown in FIG. 2. The powder showed desirable sphericity, where most of powder particles had a smooth surface, and a small part had a certain proportion of satellite powder. The particles with the largest size were below 70 μm, while there was less small-size powder, and most of the particles had a particle size distribution of 10 μm to 60 μm, which were suitable for LPBF. The powder with a particle size of 15 μm to 53 μm was baked at 110° C. for 3 h.

Step 3, the baked powder was printed in a powder supply chamber of an LPBF printer, where the LPBF was conducted at a laser power of 375 W, a scanning speed of 1,400 mm/s, a scanning line spacing of 140 μm, and a substrate preheating temperature of 150° C.

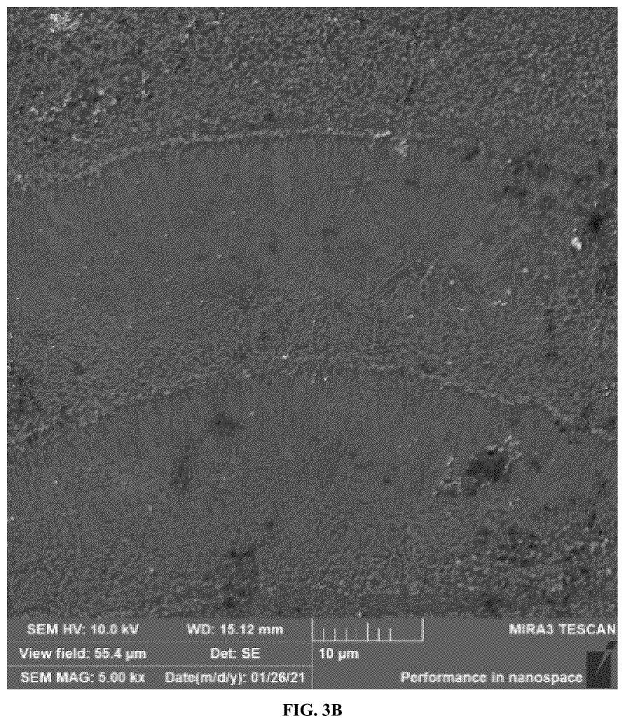

Step 4, a printed experimental block was separated from the substrate by wire cutting to prepare a metallographic sample and measure the density. The finished product was shown in FIG. 3A-B, where (a) was a light microscope image of the LPBF processed part, and it was seen that the formed sample had a high density and no obvious defects; and (b) was a post-corrosion microstructure image of the LPBF processed part, and it was seen that a single molten pool was 100 μm to 150 μm in width and 20 μm to 40 μm in depth. In addition, the reinforced particles showed non-uniform distribution in different regions of the molten pool.

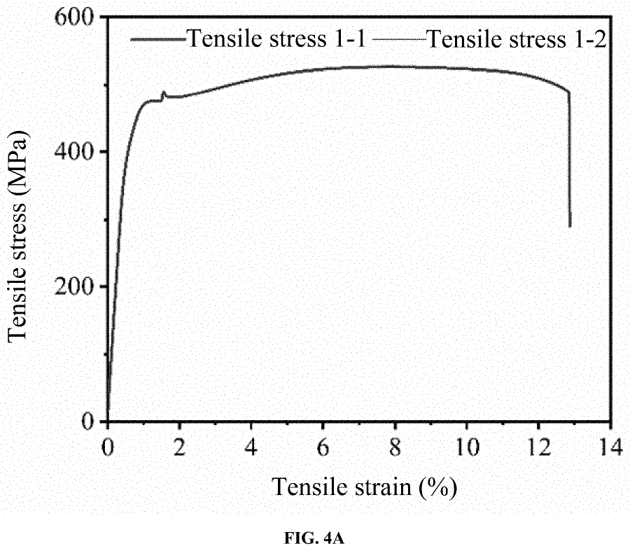

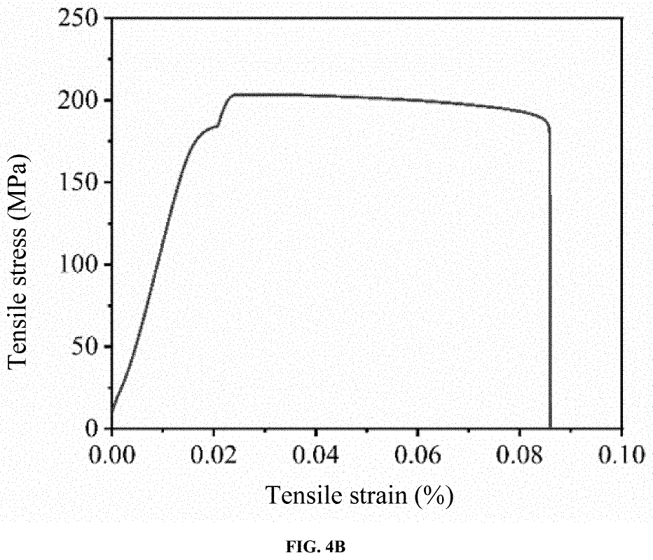

Step 4, mechanical properties of the part were determined under the optimal process parameters. Referring to FIG. 4A-B , the aluminum alloy powder of this example had a density of not less than 99% through LPBF forming; from (a) it was seen that the as-deposited samples had a tensile strength of greater than or equal to 500 MPa, a yield strength of greater than or equal to 400 MPa, and an elongation of greater than or equal to 8% at room temperature; it was seen from (b) that the as-deposited samples had a tensile strength of greater than or equal to 200 MPa, a yield strength of greater than or equal to 160 MPa, and an elongation of greater than or equal to 8% at 350° C.

### EXAMPLE 2

Step 1, a three-dimensional diagram of an experimental block with optimized process parameters was drawn, and layered slicing was conducted with a scanning strategy at a rotation angle between adjacent layers of 50° and a layer thickness of 0.025 mm.

Step 2, an aluminum alloy powder to be baked was prepared, and the aluminum alloy powder included the following components: 1% of Fe, 2.0% Cu, 1.8% of Cr, 0.8% of Ti, 0.6% of Zr, and Al as a balance. The powder with a particle size of 15 μm to 53 μm was baked at 115° C. for 3 h.

Step 3, the baked powder was printed in a powder supply chamber of an LPBF printer, where the LPBF was conducted at a laser power of 350 W, a scanning speed of 1,200 mm/s, a scanning line spacing of 120 μm, and a substrate preheating temperature of 155° C.

Step 4, a printed experimental block was separated from the substrate by wire cutting to prepare a metallographic sample and measure the density and mechanical properties.

### EXAMPLE 3

Step 1, a three-dimensional diagram of an experimental block with optimized process parameters was drawn, and layered slicing was conducted with a scanning strategy at a rotation angle between adjacent layers of 63° and a layer thickness of 0.3 mm.

Step 2, an aluminum alloy powder to be baked was prepared, and the aluminum alloy powder included the following components: 1.8% of Fe, 2.5% Cu, 1.5% of Cr, 1.1% of Ti, 0.8% of Zr, and Al as a balance. The powder with a particle size of 15 μm to 53 μm was baked at 120° C. for 2 h.

Step 3, the baked powder was printed in a powder supply chamber of an LPBF printer, where the LPBF was conducted at a laser power of 400 W, a scanning speed of 1,300 mm/s, a scanning line spacing of 130 μm, and a substrate preheating temperature of 150° C.

Step 4, a printed experimental block was separated from the substrate by wire cutting to prepare a metallographic sample and measure the density and mechanical properties.

### EXAMPLE 4

Step 1, a three-dimensional diagram of an experimental block with optimized process parameters was drawn, and layered slicing was conducted with a scanning strategy at a rotation angle between adjacent layers of 43° and a layer thickness of 0.027 mm.

Step 2, an aluminum alloy powder to be baked was prepared, and the aluminum alloy powder included the following components: 2.5% of Fe, 1.5% Cu, 1.4% of Cr, 0.9% of Ti, 0.9% of Zr, and Al as a balance. The powder with a particle size of 15 μm to 53 μm was baked at 120° C. for 2 h.

Step 3, the baked powder was printed in a powder supply chamber of an LPBF printer, where the LPBF was conducted at a laser power of 360 W, a scanning speed of 1,250 mm/s, a scanning line spacing of 125 μm, and a substrate preheating temperature of 160° C.

Step 4, a printed experimental block was separated from the substrate by wire cutting to prepare a metallographic sample and measure the density and mechanical properties.

### EXAMPLE 5

Step 1, a three-dimensional diagram of an experimental block with optimized process parameters was drawn, and layered slicing was conducted with a scanning strategy at a rotation angle between adjacent layers of 37° and a layer thickness of 0.03 mm.

Step 2, an aluminum alloy powder to be baked was prepared, and the aluminum alloy powder included the following components: 2.5% of Fe, 1.8% Cu, 2% of Cr, 0.8% of Ti, 0.6% of Zr, and Al as a balance. The powder with a particle size of 30 μm to 45 μm was baked at 120° C. for 3.5 h.

Step 3, the baked powder was printed in a powder supply chamber of an LPBF printer, where the LPBF was conducted at a laser power of 365 W, a scanning speed of 1,350 mm/s, a scanning line spacing of 135 μm, and a substrate preheating temperature of 170° C.

Step 4, a printed experimental block was separated from the substrate by wire cutting to prepare a metallographic sample and measure the density and mechanical properties.

### EXAMPLE 6

Step 1, a three-dimensional diagram of an experimental block with optimized process parameters was drawn, and layered slicing was conducted with a scanning strategy at a rotation angle between adjacent layers of 23° and a layer thickness of 0.029 mm.

Step 2, an aluminum alloy powder to be baked was prepared, and the aluminum alloy powder included the following components: 2.3% of Fe, 2.2% Cu, 1.7% of Cr, 0.75% of Ti, 0.5% of Zr, and Al as a balance. The powder with a particle size of 15 μm to 53 μm was baked at 115° C. for 2.5 h.

Step 3, the baked powder was printed in a powder supply chamber of an LPBF printer, where the LPBF was conducted at a laser power of 355 W, a scanning speed of 1,400 mm/s, a scanning line spacing of 140 μm, and a substrate preheating temperature of 180° C.

Step 4, a printed experimental block was separated from the substrate by wire cutting to prepare a metallographic sample and measure the density and mechanical properties.

### EXAMPLE 7

Step 1, a three-dimensional diagram of an experimental block with optimized process parameters was drawn, and layered slicing was conducted with a scanning strategy at a rotation angle between adjacent layers of 67° and a layer thickness of 0.03 mm.

Step 2, an aluminum alloy powder to be baked was prepared, and the aluminum alloy powder included the following components: 2.2% of Fe, 3% Cu, 2% of Cr, 0.6% of Ti, 0.4% of Zr, and Al as a balance. The powder with a particle size of 15 μm to 53 μm was baked at 120° C. for 4 h.

Step 3, the baked powder was printed in a powder supply chamber of an LPBF printer, where the LPBF was conducted at a laser power of 340 W, a scanning speed of 1,000 mm/s, a scanning line spacing of 100 μm, and a substrate preheating temperature of 190° C.

Step 4, a printed experimental block was separated from the substrate by wire cutting to prepare a metallographic sample and measure the density and mechanical properties.

### EXAMPLE 8

Step 1, a three-dimensional diagram of an experimental block with optimized process parameters was drawn, and layered slicing was conducted with a scanning strategy at a rotation angle between adjacent layers of 45° and a layer thickness of 0.025 mm.

Step 2, an aluminum alloy powder to be baked was prepared, and the aluminum alloy powder included the following components: 2.4% of Fe, 2.5% Cu, 1.2% of Cr, 0.7% of Ti, 0.8% of Zr, and Al as a balance. The powder with a particle size of 15 μm to 53 μm was baked at 115° C. for 4 h.

Step 3, the baked powder was printed in a powder supply chamber of an LPBF printer, where the LPBF was conducted at a laser power of 325 W, a scanning speed of 1,300 mm/s, a scanning line spacing of 130 μm, and a substrate preheating temperature of 160° C.

Step 4, a printed experimental block was separated from the substrate by wire cutting to prepare a metallographic sample and measure the density and mechanical properties.

### EXAMPLE 9

Step 1, a three-dimensional diagram of an experimental block with optimized process parameters was drawn, and layered slicing was conducted with a scanning strategy at a rotation angle between adjacent layers of 55° and a layer thickness of 0.03 mm.

Step 2, an aluminum alloy powder to be baked was prepared, and the aluminum alloy powder included the following components: 2.4% of Fe, 2.2% Cu, 1.3% of Cr, 0.5% of Ti, 0.9% of Zr, and Al as a balance. The powder with a particle size of 15 μm to 53 μm was baked at 113° C. for 3.5 h.

Step 3, the baked powder was printed in a powder supply chamber of an LPBF printer, where the LPBF was conducted at a laser power of 330 W, a scanning speed of 1,150 mm/s, a scanning line spacing of 120 μm, and a substrate preheating temperature of 180° C.

Step 4, a printed experimental block was separated from the substrate by wire cutting to prepare a metallographic sample and measure the density and mechanical properties.

### EXAMPLE 10

Step 1, a three-dimensional diagram of an experimental block with optimized process parameters was drawn, and layered slicing was conducted with a scanning strategy at a rotation angle between adjacent layers of 35° and a layer thickness of 0.027 mm.

Step 2, an aluminum alloy powder to be baked was prepared, and the aluminum alloy powder included the following components: 2.2% of Fe, 1.9% Cu, 1.6% of Cr, 0.8% of Ti, 0.7% of Zr, and Al as a balance. The powder with a particle size of 15 μm to 53 μm was baked at 112° C. for 4 h.

Step 3, the baked powder was printed in a powder supply chamber of an LPBF printer, where the LPBF was conducted at a laser power of 335 W, a scanning speed of 1,150 mm/s, a scanning line spacing of 135 μm, and a substrate preheating temperature of 195° C.

Step 4, a printed experimental block was separated from the substrate by wire cutting to prepare a metallographic sample and measure the density and mechanical properties.

The above described are merely preferred embodiments of the present disclosure, and not intended to limit the present disclosure. Any modifications, equivalent replacements and improvements made within the spirit and principle of the present disclosure should all fall within the scope of protection of the present disclosure.

What is claimed is:

1. An aluminum alloy workpiece, comprising the following components by mass fraction: 1.0% to 2.5% of Fe, 1.5% to 3.0% of Cu, 1.0% to 2.0% of Cr, 0.5% to 1.1% of Ti, 0.4% to 1.0% of Zr, and Al as a balance.

2. The aluminum alloy workpiece according to claim 1, comprising less than 0.2% of impurity elements by mass fraction.

3. The aluminum alloy workpiece according to claim 1, comprising greater than 2.5% and less than 3.5% of Fe and Cr in total by mass fraction.

4. The aluminum alloy workpiece according to claim 1, comprising less than 2.0% of Ti and Zr in total by mass fraction.

5. The aluminum alloy workpiece according to claim 1, comprising less than 0.01% of oxygen by mass fraction.

6. The aluminum alloy workpiece according to claim 1, having a tensile strength of greater than or equal to 500 MPa at room temperature.

7. The aluminum alloy workpiece according to claim 1, having a yield strength of greater than or equal to 400 MPa at room temperature.

8. The aluminum alloy workpiece according to claim 1, having an elongation of greater than or equal to 8% at room temperature.

9. The aluminum alloy workpiece according to claim 1, having a tensile strength of greater than or equal to 200 MPa at 350° C.

10. The aluminum alloy workpiece according to claim 1, having a yield strength of greater than or equal to 160 MPa at 350° C.

11. The aluminum alloy workpiece according to claim 1, having an elongation of greater than or equal to 8% at 350° C.

12. A preparation method of the aluminum alloy workpiece according to claim 1, comprising the following steps:
step 1, draw a three-dimensional diagram of a workpiece to be prepared, and formulating process parameters during printing; and
step 2, printing a configured and baked aluminum alloy powder in a laser powder bed fusion (LPBF) printer to obtain the aluminum alloy workpiece.

13. The preparation method of the aluminum alloy workpiece according to claim 12, wherein in step 1, the process parameters comprise a laser power, a scanning speed, a scanning line spacing, a rotation angle, a layering thickness, an oxygen content, and a substrate preheating temperature.

14. The preparation method of the aluminum alloy workpiece according to claim 12, wherein in step 2, a particle size distribution of the aluminum alloy powder comprises: a D10 powder has a particle size of 10 μm to 25 μm, a D50 powder has a particle size of 30 μm to 45 μm, and a D90 powder has a particle size of 50 μm to 60 μm.

15. The preparation method of the aluminum alloy workpiece according to claim 12, wherein in step 2, the aluminum alloy powder is baked at 100° C. to 120° C. for 2 h to 4 h.
